(19) United States
(12) Patent Application Publication
(10) Pub. No.: US 2009/0272335 A1
(43) Pub. Date: Nov. 5, 2009

(54) Wound disturbance protection device

(76) Inventors: Richard M. Cooke, JR., Lake Forest, CA (US); Diane Lee Cooke, Lake Forest, CA (US)

Correspondence Address: CURTIS L. HARRINGTON, Suite 250, 6300 State University Drive, Long Beach, CA, 90815, US

(21) Appl. No.: 12/151,044

(22) Filed: May 1, 2008

(51) Int. Cl. A01K 13/00; A01K 15/04

(52) U.S. Cl. 119/822; 119/850

(57) ABSTRACT

A wound disturbance protection device can utilize a small replaceable battery of about three volts, and utilizes a circuit board containing a micro-controller, a sensible voltage output circuit, which may have a direct current or an alternating current output, and an extended tongue or other structure touch circuit having a replaceable flexible adhesive backed electrical circuit. The flexible circuit is preferably attached in a spiral fashion to present an alternating set of conductors and may preferably be used atop a bandage. The applied shock is only external to the bandage and will thus be localized to the animals sense organs on touch and will avoid any possibility of current and voltage coursing through other parts of the animal's body.

### BACKGROUND OF THE INVENTION

This invention relates to a method and technique for providing a long lasting, safe and power conserving device to inhibit wounded animals from harming their wounds and damaging their dressings.

### BACKGROUND OF THE INVENTION

Animals which have the ability to molest their healing wounds cause a lot of problems for themselves and for their owners. Where a pet owner takes the pet to a veterinarian, significant time and money is spent to place the pet in a position to maximize chances for recovery. In some cases it is desired to isolate an injured part of the pet's body from the pet's ability to bite or chew it as well as to bite or chew any dressing or other healing structure. Other healing structures may include bandages, sleeves, pins and in some cases a wound area covering. Further the areas to be isolated may or may not be actual physical injury areas, but may be a rash or an infection.

Restraining structures have been employed to try and constrain the pet from damaging either the injured area or the healing structure. These can cause the pet significant discomfort. One example is the Elizabethan collar (E-collar) neck cone which can annoy the animal to the point of distraction. Other less annoying structures include electrical apparatus for prevention of wetted chewing of the affected area. For Example, U.S. Pat. No. 5,896,830 to Stampe entitled “ELECTRICAL APPARATUS FOR DISCOURAGING ANIMALS FROM INSTINCTIVELY LICKING THEIR WOUNDS” discloses a fold-over apparatus capturing a battery in the fold and uses a flat self-adhesive layer for direct pressure sensitive sticking to an area near the wound. The device of Stampe has several limitations. First, the device has a very abbreviated area and yet has to depend only upon being stuck only flatly near the wound. It has a powerful adhesive and is prone to being nudged off without an overwhelming power of such adhesive, given its relatively small adhesion footprint. Further, the electrical current is based upon a simple short circuit. This includes two severe limitations. First, the voltage and current is based upon the voltage and internal resistance of the battery. This means that a single lick can produce a closed circuit which can deplete the battery in a short period of time. Other conductive short circuits from mud puddles or salt water can also deplete the circuit power. In effect, this device might, depending upon the viscosity and conductivity of the animal's saliva, become a one lick device. If the device is not believed to be effective with one battery, a user can stack two or three additional batteries in series to increase the voltage and current. The “folding action” of the “energization switch” enables more batteries to be added to the stack. Second, there is no way to control the conduction once it begins. At best this can deplete the battery source in a few minutes. At its worse it can cause local heating in either the conductive traces or battery or both and burn the animal. An owner who finds that the device is not working can thus try to increase the voltage but only by increasing the danger by adding more batteries to increase voltage and also increase the burn danger.

Similarly, U.S. Pat. No. 4,153,009 to William Boyle entitled “ELECTRIC SHOCK TRAINING DEVICE FOR ANIMALS” uses a pair of 9 volt batteries connected in series to supply, with a three conductor bus bar where the center bus bar is negative and two adjacent bus bars are positive. The assembly is attached using the housing and bus bar support and has a method for attaching the end of the bus bar support back to the housing. The apparatus overlies what might be characterized as a conventional dressing. The Boyle device is not much different from Stampe in that it simply attempts to provide a much higher voltage by using a pair of nine volt batteries. The short circuit danger in the Boyle device is still a significant danger.

Other devices include U.S. Pat. No. 7,219,627 to Egloff entitled “ELECTRICAL BANDAGE PROTECTOR” and in which a battery of from 9 to 12 volts is used, but with a fuse to prevent over heating upon short circuit. The Egloff device and the Egloff reference teaching both at least contemplate the danger of using a battery power supply, but the use of a fuse which must be continually replaced does neither the owner nor the healing animal any favors.

In another device, U.S. Pat. No. 6,561,136 to Charles Kuntz entitled “ELECTRONIC DEVICE FOR VETERINARY PATIENTS” teaches the construction of an insulated dressing with a conductive cover. A shock device is connected between the conductive outer layer and the animal's body such that any chewing on the conductive exterior of the bandage completes a circuit through the inside of the animal's body to give a “head conductive” shock sensation. In one figure it is clear that one electrode is connected away from the bandage and near the animal's chest to direct current through the animal's chest as a manner of completing the circuit. In an injured animal, causing current to course through parts of the body could be deleterious given the potential for a weakened animal or the opportunity for internal current flow to disrupt what may already be weakened internal organs. The defibrillative orientation of the electrodes taught by Kuntz should be avoided. Further, the animal with the Kuntz device will receive a shock if his dressing becomes wet and if it touches any other part of his body. This can result in an animal who is punished with electrical body shock based upon how it sits or lies, even if the wound area is not chewed or molested.

In all of the foregoing examples, battery depletion, over current danger with heating or burning is a potential problem, among others. But a further problem involves the damage to the injured animal due to a discouragement device which fails. Failure of such a device can actually encourage an animal to further destroy the dressing and further inflict damage to the wound or inflamed area. Further, the animal's owner cannot tell whether the device is functioning or not merely upon inspection. The user must either obtain a voltmeter to see if the device is still working, or lick the electrodes as a test. From the injured animal's perspective the device “teaches” the animal to avoid the wounded or inflamed area. When the device is tested by the animal and it does not work, it invites the animal to continue to invade the area originally sought to be protected. Further, where a batter is used which is depleted of voltage and current over time, the animal is taught that each molestation of the forbidden area becomes easier. In effect, the animal is taught that persistence will be rewarded with diminished resistance.

What is needed is a body protector for an animal which (1) eliminates the possibility of a depleting short circuit, (2) which indicates that it is functioning, (3) which has the ability to deliver a more noticeable yet safer training shock to the animal, and (4) which has the ability to dissuade the animal by delivering shocks of either increased or random intensity over time to teach the animal away from the perception that increased persistence will result in a diminished response for the area to be protected.

### SUMMARY OF THE INVENTION

A pet bandage protection system can utilize a small replaceable battery of about three volts, and utilizes a circuit board or flex circuit, containing a micro-controller, a DC-DC converter and an extended tongue touch circuit having a replaceable flexible adhesive backed electrical circuit. The flexible circuit is preferably attached in a spiral fashion to present an alternating set of conductors and may preferably be used atop a bandage. The applied shock is only external to the bandage and will thus be localized to the animals sense organs on touch and will avoid any possibility of current and voltage coursing through other parts of the animal's body.

When the micro-controller detects the pet's tongue or mouth touching the flexible circuit a change in resistance is detected through the flexible circuit, and the microprocessor directs a mild, time duration limited pulsed shock of (using the components described) up to twenty eight to thirty volts direct current or less or more through the flexible circuit. Other designs are possible which have different voltage and current ratings. The use of a direct current-direct current converter enables a battery nominally rated at three volts to output twenty-eight volts such that the output is between nine and ten times the battery voltage. Battery consumption is conserved as the micro-controller spends the majority of the time in a “sleep” mode. At regular intervals the micro-controller wakes up measures the battery voltage and flashes the green LED if the battery voltage is in the acceptable range. This flashing assures the animal care giver that the device is working and has sufficient power. If the battery voltage is low the micro-controller will flash a red LED to indicate the need for a battery change. Thus, the animal care giver will always quickly be able to ascertain the operating status of the system visually. The battery is replaceable so the invention herein will allow the end user to keep the product until the next time when any other animal requires a bandage. In an institutional setting, a veterinarian need only purchase a dozen or so of the devices, which are expected to almost never wear out.

In one embodiment, the circuit board may be attached to the flexible circuit by two thumb crews allowing the end user to readily replace the flexible circuit and save the electronics package for a later use. A flexible circuit utilizable in conjunction with the electronics package will be available separately and depending upon the surface to which it is attached it may not likely be re-usable. In an institutional setting and when used with several animals the provision of a new flexible circuit for each animal will very likely be required for sanitary purposes.

The re-usability of the electronics package will enable a lower cost of the whole system over time, to allow the end user to minimize long term cost and to be used to protect injured animals well beyond the lifetime of any given animal.

The micro-controller programming will allow a single three volt lithium coin cell to operate the protection system for up to a year. The flexible protection circuit can be made in various sizes and configurations. A twelve to forty eight inch long and three quarters of an inch wide flexible circuit may be and preferably is wrapped in a spiral to form a somewhat cylindrical structure to protect an animal's extremity. A rectangular shaped flexible circuit can be used to protect an animal's abdomen.

The electronics package is controlled by a micro-controller that is in the “low-power” mode until the resistance between the positive and negative traces decreases to a threshold setting. The low resistance condition can “awaken” the micro-controller from its low power mode and cause the DC-DC converter to be enabled. The micro-controller then energizes the flexible circuit such that the animal will then receive a mild shock. After receiving the mild shock it is expected that the animal will remove his tongue or mouth from the bandage protector. If this occurs, and then in the absence of the tongue or mouth the resistance between the traces of the flexible circuit, the resistance rapidly increases above the threshold point, and this is also detected by a tongue touch circuit such that the micro-controller enters the low power mode. This asynchronous behavior is one of the keys to long battery life, in contrast with conventional systems which must use multiple coin cell batteries (in series) and which will last only five to seven days. The design of the inventive device will allow the end user to protect a bandage for up to 1 year before the battery needs to be replaced.

Even more importantly, circumstances which would cause a false trigger will not deplete the battery nor create a burn hazard. For example, if the animal steps into a salt water puddle, the micro controller will deliver a pulse and then may wait for a change. Even where the micro controller does not detect a change after a number of pulses it may wait longer and longer between pulses and then go into sleep mode for some specified time before re-awakening and testing for a resistance threshold. The same conditions might also be created where the animal contacted metal, such as a grate or where the animal rests against a conductive structure. The use of measured, time limited pulses not only protects the animal, but also preserves the battery and prevents the animal care giver from having to continually replace batteries, as is the case for conventional devices.

The structure and operating system of the animal protector apparatus is constructed for long life and battery conservancy, including a low energy or “sleep” cycle as the predominant duty cycle until the circuit detects a low resistance condition which indicates a disturbance by the presence of an animal tongue or mouth. The firmware further maximizes the battery life by adjusting the time between shock episodes such that if a low resistance condition occurs for more than a set time, the system inhibits the shock until an ever increasing delay has expired. This will protect the battery from draining due to the pet getting the bandage and flexible circuit wet.

The generation of a dissuasion voltage of about twenty-eight volts is believed to be sufficient to train and deter the animal from licking or destroying its bandage, but without being unduly disruptive or upsetting to the animal. The modular construction of the animal protector apparatus enables the flexible circuit portion to be disposable while the circuit board portion can be used again and again. Further, the flexible circuit portion may be available in a long length and can be cut to be shorter as needed.

### BRIEF DESCRIPTION OF THE DRAWINGS

The invention, its configuration, construction, and operation will be best further described in the following detailed description, taken in conjunction with the accompanying drawings in which:

FIG. 1 is an exploded view showing a circuit board, flexible circuit and thumb connectors which attach the flexible circuit electrically and mechanically to the circuit board;

FIG. 2 is a cross sectional view of the flexible circuit taken along line 2-2 of FIG. 1, and which preferably illustrates a pair of conductors on the upper side and also having a lower layer of contact adhesive which may preferably be covered with a removable release strip;

FIG. 3 is an end view taken along line 3-3 of FIG. 1 and showing a battery mechanically held and electrically connected to the components on the circuit board, and shown opposite the assembled threaded thumb connectors which are shown attached to their respective terminals;

FIG. 4 illustrates a block diagram of one embodiment of the wound disturbance protection device;

FIG. 5 illustrates a flowchart through which the normal operating steps of power-up and ready status are indicated;

FIG. 6 illustrates detailing the steps taken upon detection of any conductive or wetted disturbance to the conductors of the flexible circuit seen in FIG. 1;

FIG. 7 illustrates one realization of a circuit which can be utilized with the animal protector apparatus seen in the foregoing figures;

FIG. 8 illustrates one variation of the one realization of a circuit which can be utilized with the animal protector apparatus as was seen in FIG. 7 with the direct current generating component replaced by an alternating current device;

FIG. 9 illustrates a leg of a dog fitted with the animal protector apparatus of the invention and seen as a spiral wrap over a bandage; and

FIG. 10 illustrates a leg of a dog fitted with the animal protector apparatus of the invention and illustrated with anchoring bandages fitted adjacent the ends of the spiral.

### DETAILED DESCRIPTION OF THE PREFERRED EMBODIMENT

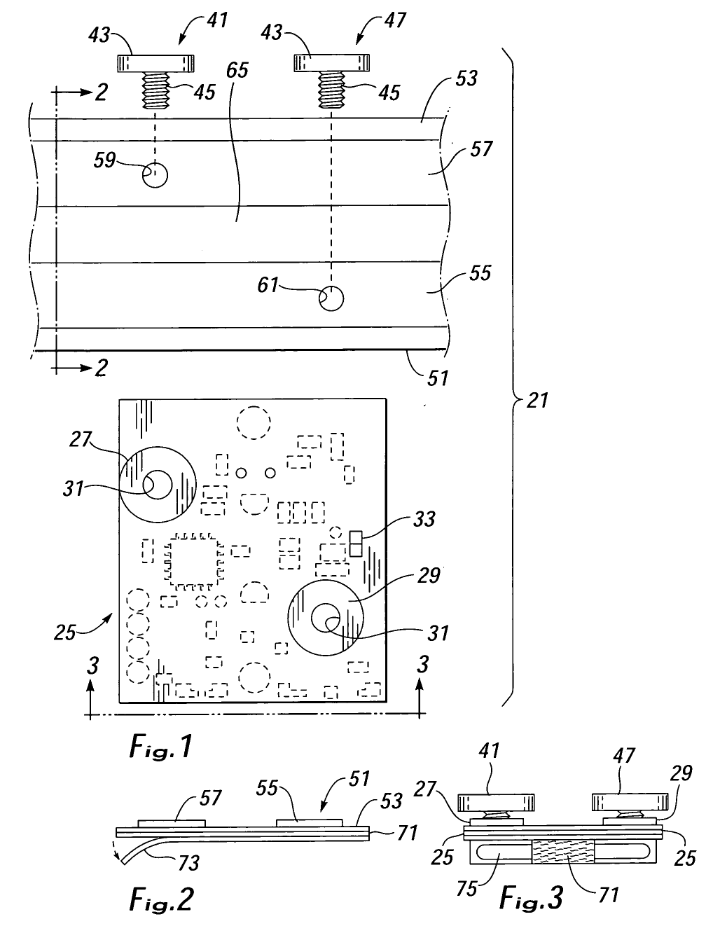

Referring to FIG. 1, an exploded view of the main parts of an animal protector apparatus 21 is illustrated. A circuit board 25 is seen as having a pair of terminals, including a first terminal 27 and a second terminal 29 each having an internally threaded bore 31. The circuit board 25 need not be rigid and can be a flex circuit with many different types of connectors as are necessary to accept power and to input and output signals. The circuit board may also have an indicator light, such as an LED 33. The other physical components on the circuit board 25 will not be identified although components will be shown in a schematic. The circuit board shown measures one inch by thirteen sixteenths of an inch. As a result of this small size, the circuit board 25 with battery attached to the rear face (not shown in FIG. 1) weighs only three tenths of an ounce.

A first threaded thumb connector 41 includes a knob 43 and a conductive threaded shaft 45. A second threaded thumb connector 47 includes a knob 43 and conductive threaded shaft 45. The threaded shafts 45 are sized to fit within the internally threaded bores 31 of the first and second terminals 27 and 29.

Between the first and second threaded thumb connectors 41 and 47 and the circuit board 25 is seen a flexible circuit 51 of indeterminate length. The left and right sides are shown with broken lines in order to illustrate that both sides of the flexible circuit 51 may extend in either direction. In one embodiment, it may be that one side may extend for several inches to a foot to enable support to be had of the circuit board 25 from either side of the flexible circuit 51. In other cases a further connection device may extend to one side. Where flexible circuit 51 is provided with several feet to either side of the section seen in FIG. 1, the user can cut and trim it as needed. Some of this need may be the method of wrapping either the area or the bandage in a manner which best fits the need of application. The user is thus free to even center the circuit board 25 where application of the flexible circuit 51 warrants it.

The flexible circuit 51 has a main expanse of non-conductive material 53 which may preferably be a flexible plastic, upon which are laid down a pair of conductors seen as conductor 55 and conductor 57. Conductor 55 has an aperture 59 while conductor 57 has aperture 61. The vertical and horizontal separation of the apertures 59 and 61 correspond to the vertical and horizontal separation of the internally threaded bores 31 of the first terminal 27 and second terminal 29 to enable the thumb connectors 41 and 47 to secure the flexible circuit 51 to the first terminal 27 and second terminal 29. This action complete both an electrical connection and a mechanical connection, especially useful where the flexible circuit 51 is used to support the circuit board 25.

It is preferable for an area 65 between the conductors 55 and 57 to be made of transparent material so that the LED 33 can be seen to flash through the flexible circuit 51. This eliminates the need to create a special configuration to insure that the LED 33 is viewable. Further, it is preferable to orient the exterior surfaces of the conductors 55 and 57 away from the circuit board 25 to insure that none of the components are inadvertently contacted. Further, the side of the flexible circuit 51 facing the circuit board 25 will preferably have a thin layer of adhesive so that the flexible circuit 51 can assume a position inside a wrapped configuration against an extremity of an animal. It is especially when used over an underlying bandage that the LED 33 can be seen flashing through the area 65 of transparent material 65.

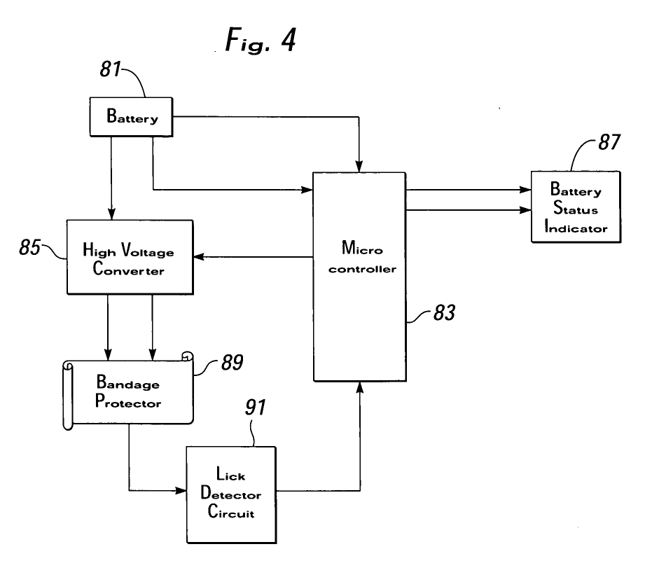

Referring to FIG. 2, a view taken along line 2-2 of FIG. 1 illustrates a cross sectional view of the flexible circuit of FIG. 1 and illustrating the conductors 55 and 57 atop the main expanse of non-conductive material 53. A layer of adhesive 71 is seen as being covered on the underside by a release sheet 73, one corner of which is partially peeled back. With this configuration, a new flexible circuit 51 need only be connected to the circuit board 25 using the thumb connectors 41 and 47 to energize the conductors 55 and 57, then remove the release sheet 73 to expose the layer of adhesive 71, and then apply the animal protector apparatus 21 over the area to be protected by contact of the area to be protected by contact with the adhesive 71 to either the animal's skin or to the animal's bandage, wrap or other area preparation. In this position, the LED 31 will be visible through the area of transparent material 65.

FIG. 3 is a view taken along line 3-3 of FIG. 1 and illustrates a view illustrating both the top and bottom sides of the circuit board 25. The threaded thumb connectors 41 and 47 can be seen attached to the first and second terminals 27 and 29. A lower battery contact and support 71 is shown supporting a battery 75 in a very stable support configuration. Battery 75 is well supported and can be removed only by deliberate action of the user.

Referring to FIG. 4 a simplified block diagram of one configuration of the animal protector apparatus 21 is illustrated. As by FIG. 1, all of the components will ideally be supported on the circuit board 25. A battery 81 supplies power to a micro controller 83 and to a High Voltage Converter 85. High Voltage Converter 85 may preferably be a direct current voltage several times the battery voltage, or it may be an alternating current alternating voltage source, also preferably several times the battery supply voltage. The battery power may also be supplied separately to the micro controller 83 for purposes of voltage monitoring. A battery status indicator 87 may preferably be a multi-color LED such as the LED 33 seen in FIG. 1.

The High Voltage Converter 85 may be connected to the bandage protector 89, which is expected to be the flexible circuit 51 seen in FIG. 1. It should be noted that other types of bandage protector 89 can be configured to work with the circuit board 25 or as part of the animal protector apparatus 21, and thus the bandage protector 89 is a more generalized structure. A lick detector circuit 91 is shown as connected to the bandage protector 89 and to the micro-controller 83. This circuit may operate to detect animal tongue contact with the flexible circuit 51 through several methods, including the detection of reduced resistance between the terminals 27 and 29, and between the conductors 55 and 57 such that current flows, a resulting reduction in the threshold voltage between terminals 27 and 29 occurs. Further, the lick detector circuit 91's connection to the micro controller 83 may be isolated at a time when the micro controller 83 triggers a shock enable signal from the micro controller 83. This may insure that any delicate measurement circuitry within the micro controller 83 will have a reduced chance of damage when the DC-DC boost voltage converter is triggered.

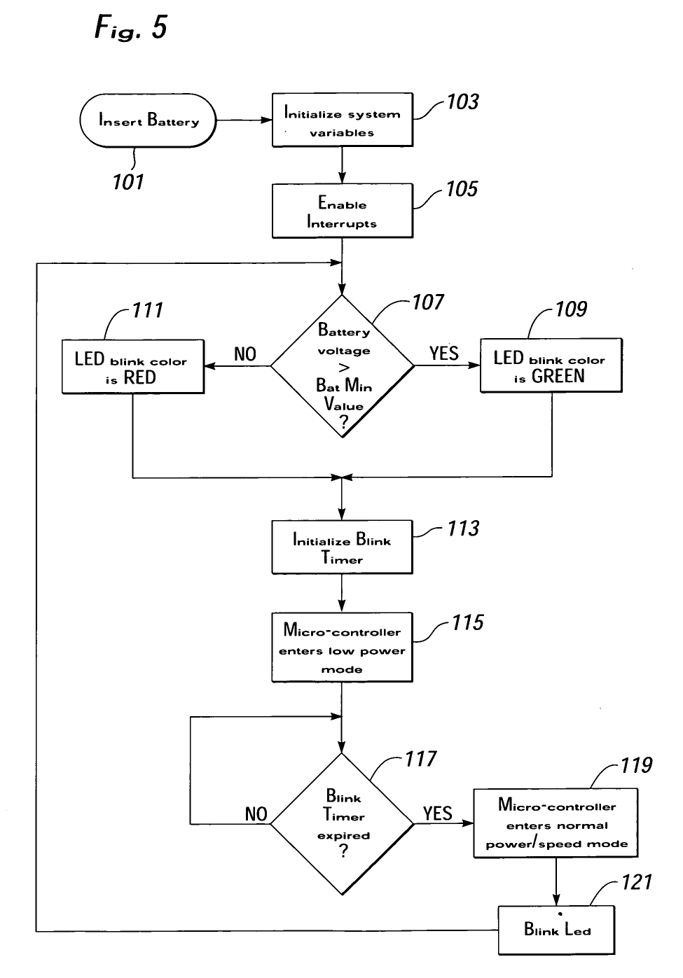

Referring to FIG. 5, a logic flowchart showing but one possible approach in programming of the micro-controller 83 is illustrated. It is understood that the interrupt based approach is for simplicity in illustrating the operation of the circuitry. As a starting point an “insert battery” starting oval 101 is utilized as the circuit board 25 will preferably have no “on/off” switch, and simple insertion of a battery 75 will start operations and logic flow. In order to save weight and expense, and due to the one year expected battery life under normal use conditions, battery insertion marks the start of operations, assuming it has sufficient voltage to operate the micro controller 83. Upon startup, the logic flows to an “initialize system variables” block 103 at which time the programmed parameters are made available to the micro controller 83 operating system.

The logic next flows to an “enable interrupts” block 105 which, in an interrupt based system, enables the interrupt based operation for the logic flows and actions described for this and other flow charts at any point on the flowchart of FIG. 5 downstream of the “enable interrupts” block 105. The logic then flows to a “battery voltage>BAT_{MIN} value” decision diamond 107, where BAT_{MIN} may vary depending upon the characteristics and operability of a given circuit at its lower voltage limit. A “yes” result leads to a “LED blink color is GREEN” block 109. A “no” result leads to a “LED blink color is RED” block 111.

The logic flow from either of the “LED blink color is GREEN” block 109 or “LED blink color is RED” block 111 leads to an “initialize blink timer” block 113 which sets the base timing periodicity and cycle for operation of the animal protector apparatus 21. The logic next flows to a “micro-controller enters low power mode” block 115 which lowers the power until it is time to go back to “battery voltage>BAT_{MIN} value” decision diamond 107, as will be shown.

The logic next flows to a “blink timer expired” decision diamond 117. A “no” result leads back to the “blink timer expired” decision diamond 117. This loop occurs while the micro controller is in low power mode. The “initialize blink timer” block 113 may assign a time of 3-5 seconds during which the loop established by “blink timer expired” decision diamond 117, but the overall duty cycle may be different. A “yes” result at the “blink timer expired” decision diamond 117 leads to a “micro-controller enters normal power/speed mode” block 119. The normal power/speed mode” block 119 enables the tasks of powering the LED 33 of FIG. 1, as well as battery voltage measurement. After the logic enters the “micro-controller enters normal power/speed mode” block 119 the normal power is back on, as the logic flows through a “blink LED” block and then back to the “battery voltage>BAT_{MIN} value” decision diamond 107 and repeats the flow of logic previously described. The micro controller remains in normal power until it again encounters micro-controller enters low power mode” block 115. This program flow guarantees that the micro-controller spends the majority of the time in low power mode.

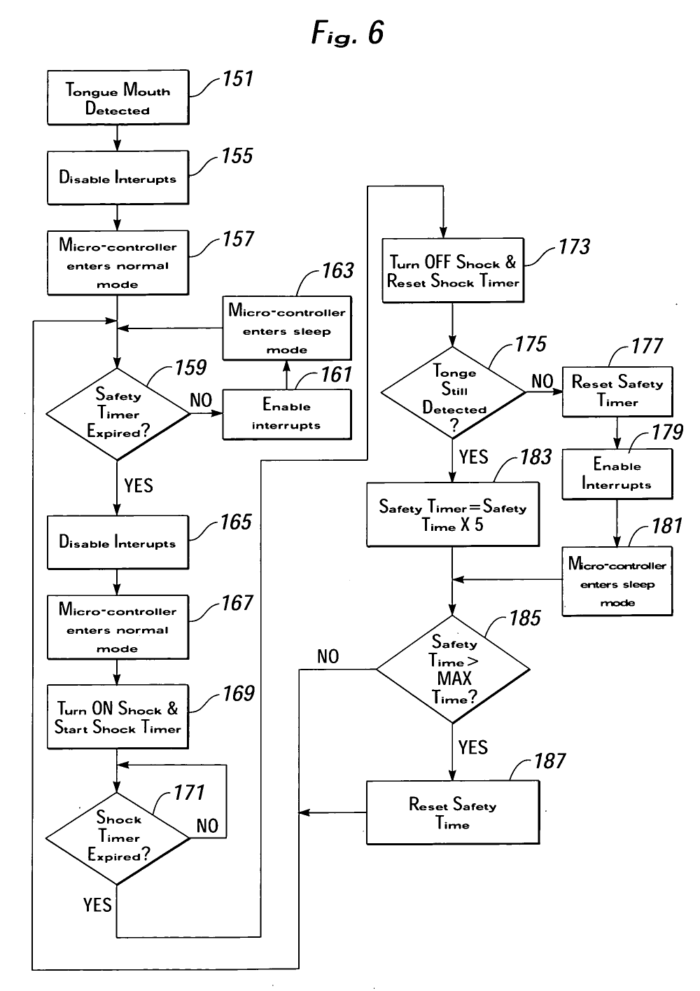

Referring to FIG. 6, one possible view of an interrupt routine is shown. The logic flow into the interrupt routine of FIG. 6 can occur from any point in the normal cyclic functioning seen in the block diagram of FIG. 5. An interrupt is triggered by the detection of disturbances in the first and second terminals 27 and 29, as well as their attached conductors 55 and 57, such as might occur by licking, moist touching or biting, is shown. The logic flow arrives at the subroutine of FIG. 6 at any time from any location in the logic flow seen in FIG. 5. The interrupt of this flow of logic may include the detection of the disturbance by lick or moist touch as the master interrupt which preempts all of the other interrupts. A “tongue or mouth detected” block 151 occurs by any of the methods discussed between the first and second terminals 27 and 29 as well as their attached conductors 55 and 57. If detection is had, the logic flows to an “disable interrupts” block 155 which acts as the master interrupt and prevents any further action or logic flow seen in FIG. 5, or any other interrupts other than those seen in FIG. 6.

The logic then flows to a “micro-controller enters normal mode” block 157 to take account of the possibility that the interrupt which triggered the arrival of the logic flow seen in FIG. 6 might have occurred while the micro-controller was in low power mode, with block 157 simply insuring that normal power mode is achieved before proceeding further.

The logic then flows to a “safety timer expired?” decision diamond 159. The safety timer is a separate category of time during which no further progress will be allowed in the interrupt logic flow of FIG. 6 due to the possible occurrence of a short or some other condition where the first and second terminals 27 and 29 remain shorted. The result of this condition, as will be seen, is that the time in this timer is multiplied times five for every passage through the interrupt sequence of FIG. 6 so that any shock occurs by half as often during a constant shorted state. For the “has safety timer expired?” decision diamond 159, a “no” result leads to an “enable interrupts” block 161 and then to a “micro controller enters sleep mode” block 163. The logic then flows back to the “has safety timer expired?” decision diamond 159. Even in sleep mode, the micro-controller 83 can continue to check to see if the safety timer is expired.

A “yes” result at the “has safety timer expired?” decision diamond 159 then permits the logic to flow to a “disable interrupts” block 165 where this shock interrupt sequence will be continued without any interrupts external to this shock interrupt sequence. The logic then flows to a “micro-controller enters normal mode” block 167 where the micro-controller 83 is fully on. The logic then flows to a “turn on shock & start shock timer” block 169. These two actions occur simultaneously where the shock is turned on and the shock timer which measures the time since the shock was turned on, are initiated. In turning on the shock, the micro-controller 83 instructs the “DC-DC Boost Voltage Converter” block 85 to turn on in order to deliver a shock. The DC-DC converter enable terminal (to be shown) receives an enablement signal and turns on less than about 50 microseconds later. Second, block 169 starts the shock timer, which may be a count-down timer, which was previously stated to have a time duration of about 1 second. The shock timer may be initially set to one second and determines the length of time that a sensible shock potential will be applied between the first and second terminals 27 and 29 as well as their attached conductors 55 and 57. The shock potential can be at any level and may be of a single wave form or a series of shorter waveforms. It has been found that one voltage value which works well as a generally constant “on” applied voltage is from about twenty five to about thirty five volts, but a user may want higher or lower voltages when dealing with different animals of different size, temperament, and different resistance lowering characteristics.

The logic flow then proceeds to a “shock timer expired?” decision diamond 171. A “no” result causes the logic to flow back to the a “shock timer expired?” decision diamond 171 which entrains the logic flow until the shock timer expires. Where the shock timer is set to one second, the entrainment or holdup will continue in this loop for about one second. Only a “yes” result at the a “shock timer expired?” decision diamond 171 allows the logic to flow to a “turn off shock & reset shock timer” block 173. This ends the actual shock and timing step and allows the logic to continue on.

The logic then flows to a “tongue still detected” decision diamond 175 at which time the detection of the same type of voltage lowering/shorting event between the conductors 55 and 57 is tested. This condition may be due to an aggressive animal continuing to lick and chew at the wound area, or it could result from a short circuit where the conductors 55 and 57 are pressed against a third body conductor. Since the animal protector apparatus 21 may not be able to distinguish whether the animal is being aggressive or whether there is a short present, any low resistance between conductors 55 and 57 will be considered to be a short and a safety timer will be used to increase the permissible period between shocks under that assumption. It is thus assumed that an animal will quickly draw away from a twenty five to thirty five volt shock and that, absent the need for a safety timer that subsequent shocks will be due to a fresh molestation of the wound area.

The way that the animal protector apparatus 21 reacts to continued shorting is to perform a calculation where greater and greater amounts of time are added between shocks. This increased time will conserve power by either increasing the period between shocks to either enable the animal to move away from a conductor or to allow the animal protector apparatus 21 to dry should it become wet with a conductive liquid.

As can be seen, if no further conductor is detected, as would be the case where the animal is dissuaded from molesting the area to be protected, the animal protector apparatus 21 is returned to a normal service. In its return to normal service, a “no” result at “tongue still detected” decision diamond 175 leads to a “reset safety timer” block 177. Here, any past safety times due to continued shorting, will be reduced to the standard time, which may be set at one second. The logic then flows to an “enable interrupts” block 179, where other interrupts, including a return to this interrupt routine is enabled. The logic then flows to a “micro-controller enters sleep mode” block 181. This puts the micro-controller 83 in its low power mode. Note from the interrupt driven logic that the re-entry to the flowchart of FIG. 5 is not required to re-enter at any given point or it can re-enter at the point from which the logic flow of FIG. 5 was interrupted.

In the event that the conductors 55 and 57 are still shorted, a safety timer routine starts at a “yes” result at the a “tongue still detected” decision diamond 175 which leads to a “safety time=safety time×5” block 183. The starting safety time might be as little as one second and was encountered at “safety timer expired?” decision diamond 159. The first time through the logic flow of FIG. 6, if the safety time was one second, the “yes” result at a “tongue still detected” decision diamond 175 causes that safety time to be multiplied by five, for example. The safety time would then be set to five times the current value, for example, five seconds. The logic then flows to a “safety time>max time?” decision diamond 185 where a large number is compared with the current safety time to cause it to re-set if it exceeds some large value. A “yes” result leads to a “reset safety time” block 187 where the safety time is re-set to its programmed minimum, which may be about one second. A “no” result, as well as the logic flow from the “reset safety time” block 187 leads directly back to re-entry of the logic flow back into the “safety timer expired?” decision diamond 159.

As by example, if the conductors 55 and 57 become shorted, as when an animal runs through a salt puddle, or perhaps rests on a conductive object, a device which continually sends out a shock would deplete the battery. But generally, animal protector apparatus 21 can't distinguish between the conditions which create the short in the conductors 55 and 57. The method for handling a continued shorting of the conductors 55 and 57 is as follows. When a short condition occurs, the first pass through the interrupt diagram of FIG. 6 will have a safety time equal to the minimum, and the “safety timer expired?” decision diamond 159 will cause further progress through the interrupt sequence of FIG. 6 to be momentarily entrained for the duration of the safety time, which we will assume to be one second. After the logic goes through a shock sequence from block 165 through block 175, if a short is detected or if the animal is aggressive in attacking the protected area, the “safety time=safety time×5” block 185 will multiply this one second time by five, and thus the safety time will be five seconds. The logic flow in the interrupt sequence of FIG. 6 will return to the “safety timer expired?” decision diamond 159 but will now cause further progress through the interrupt sequence of FIG. 6 to be momentarily entrained for the duration of the safety time, now five seconds.

Another passage through the interrupt sequence of FIG. 6, including the shock sequence from block 165 through block 175 will be had and if a short continues to be detected the “safety time=safety time×5” block 185 will multiply this five second time by five, and thus the safety time will be twenty five seconds. The logic flow in the interrupt sequence of FIG. 6 will return to the “safety timer expired?” decision diamond 159 but will now cause further progress through the interrupt sequence of FIG. 6 to be momentarily entrained for the duration of the safety time, now twenty five seconds.

The result of this example is that the time spacing between shocks under conditions where a short is detected will continue in an increasing sequence of five, twenty five, one hundred twenty five, six hundred, three thousand, etc. seconds. If this sequence is continued, it can be seen that the animal protector apparatus 21 would otherwise continue its spacing and would have a period between shocks on the order of days, weeks and months, only limited by the micro-controller's ability to count time. This ability to add an ever increasing time between shock sequence is limited by the “safety time>max time?” decision diamond 185, which simply specifies a maximum time which, when reached, causes the animal protector apparatus 21 and the process flows of FIG. 6 to simply start over and go through its sequence of five, twenty five, one hundred twenty five, six hundred, three thousand, etc. seconds between shocks. Again, any time that a short is not detected, at “tongue still detected” decision diamond 175, the control is returned to the main process flow diagram of FIG. 5.

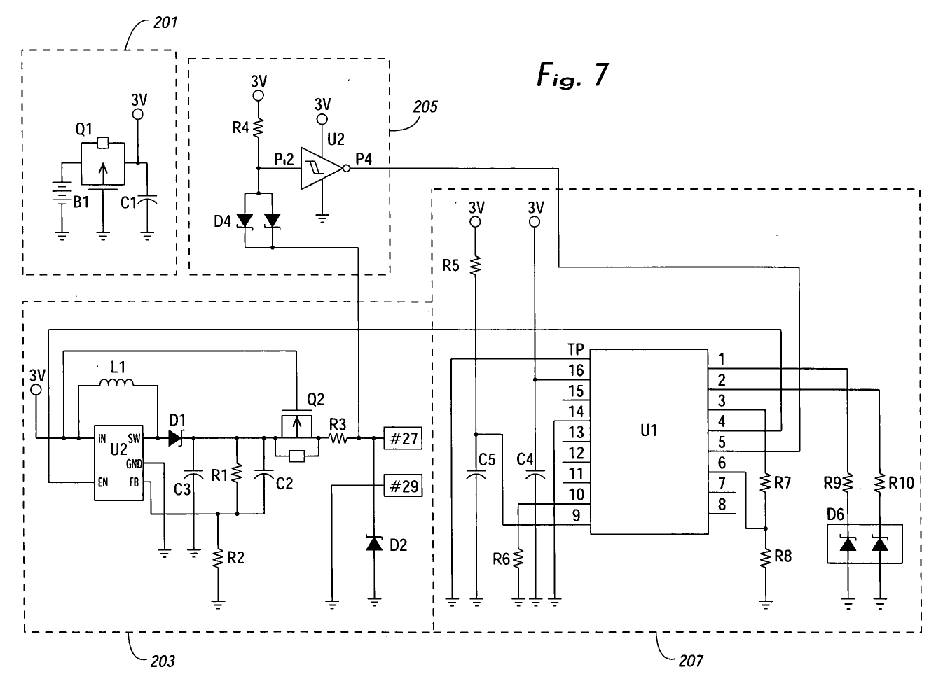

Referring to FIG. 7, one realization of a circuit to be mounted on the circuit board 25 is shown. The circuit has four main sections, including a battery input and protection section 201, a DC-DC converter section 203, a potential detection section 205, and a micro controller section 207. The battery input section 201 includes a battery B1 is connected through a MOSFET transistor Q2 to provide reverse battery polarity protection and a lower forward voltage drop than a discrete diode to help the battery B1 last longer. The three volt potential at the output of the transistor Q2 is made available to other components in the circuit with connections seen at the circle structure adjacent the designation “3V”. This supply voltage is also connected to ground through a capacitor C1 (4.7 μf).

In the a DC-DC converter section 203, the DC-DC converter U2 may be of the type commercially available from Fairchild company, part No. FAN5333BSX. The DC-DC converter U2 has five connections including an input IN, switch SW, ground GND, enable EN and feedback FB. The voltage supply, seen as a 3V circle connection is made available to the input IN. Contacts IN and SW are connected by an inductor L1 (which may range from 4.7 to 10.0 μH depending upon voltage & other characteristics desired). DC-DC converter U2 output is connected through zener diode D1 to MOSFET Q1, and to ground through a parallel combination of R1 (2.2M) and C2 (22 pF) in series with resistor R2 (100 k). The other side of MOSFET Q2 is connected through R3 to one of the conductor 55 or conductor 57, and to ground through a zener diode D2. The diode D2 protects the output line from electrostatic discharge (ESD) damage. The other of the conductor 55 or conductor 57 is connected to ground.

The potential detection section 205 includes a Schmitt trigger inverter U3 having an input connected though a pair of zener diodes D4 to the output of the resistor R3. The input of inverter U3 is normally high, being pulled up to about three volts across R4 high, thus causing its output to be normally low. When an animal's tongue or mouth is applied across the first and second terminals 27 and 29 and the flexible circuit's conductors 55 and 57, U3's input voltage will be brought below its threshold to flip the output voltage of U3 to high and transmit this result to an input of U1 in the a micro controller section 207. The lower voltage rail of inverter U3 is connected to ground. The inverted output of inverter U3 is made available to the a micro controller section 207.

The micro controller section 207 includes a micro controller U1 having connections TP and connection 14 connected to ground, connection 16 connected to the three volt power supply, unused connections 15, 13, 12, 11, 7 & 8. Micro controller U1 has connection 10 connected through a resistor R6 (47 k) connected to ground and a connection 9 connected through capacitor C5 (2200 pF) to ground and through a resistor R5 (47 k) to the three volt power supply.

Connections 1 and 2 of micro controller U1 are connected through resistors R9 and R10, respectively to LED 33 seen in FIG. 1, and thence to ground. Connection 3 is connected through a resistor R7 to connection 6, while connection 6 is connected to ground through a resistor R8 (27.4 k). Connection 4 of the micro controller U1 is connected to the enable input EN of the DC-DC converter U2.

Referring to FIG. 8, the a DC-DC converter section 203 seen in FIG. 7 is replaced by an alternating current generation section 211. As an alternative to a sinusoidal AC signal, a switch could be placed at the output of U2 seen in FIG. 7 to give a switched alternating potential output. In the sinusoidal output circuit of FIG. 8, and as before, battery power is generated by the battery input and protection section 201, and is made available to a transistor Q3 (2N2222) with the output of transistor Q3 leading to an input of transistor Q4 (2N2907) and then to ground. The bases of the transistors Q3 and Q4 are joined and connected through a resistor R11 (100 ohms) and indicated as extending to the enablement line 4 of microprocessor U1.

The output of transistor Q3 and input of transistor Q4 is connected through a capacitor C11 (10 μF) and through an inductor L11 (1 μH) into a first input of a first side of a transformer TR1. The output of the first side of the transformer TR1 is connected to ground. An output side of transformer TR1 has a first terminal connected through a resistor R13 (10 k ohms) and a capacitor C13 and then to first terminal 27 and through a zener diode D11 to ground. Capacitor C13 permits a potential to be maintained between first and second terminals 27 and terminal 29 under non shock conditions, and yet passes the AC to terminal 27 under conditions of shock. The zener diode D11, and other diodes described herein, may be a Schottky diode. A second terminal of the output side of transformer TR1 is connected to second terminal 29, and grounded. In the case of FIG. 8, rather than enabling a direct current source, the enable line 4 of microprocessor U1 enables the alternating current output circuitry of alternating current generation section 211, preferably by providing a pulse train signal. The circuit of FIG. 8, depending upon the values of C11, L11 and TR1 may have an output which may have a frequency of from about 200 to 400 Hz. Referring to FIG. 9, a view of the animal protector apparatus 21 attached over a bandage 225 dressing the leg 227 of an animal. As can be seen, the circuit board 25 underlies a section of the flexible circuit 51. The circuit board 25 is oriented so that the area 65 of transparent material enables viewing of an underlying light, such as an LED 33. The flexible circuit 51 is preferably applied in a spiral pattern in a way which causes the conductors 57 and 55 to have generally even adjacent spacing. In this pattern, the animal has an opportunity to make contact with two conductors 57 and 55 even if such contact is between such conductors along different lengths of the flexible circuit 51 due to the spiraling adjacency. Contact can be made between conductors 57 and 55 across same main expanse of plastic material 53 or between adjacent spirals of the main expanse of plastic material 53.

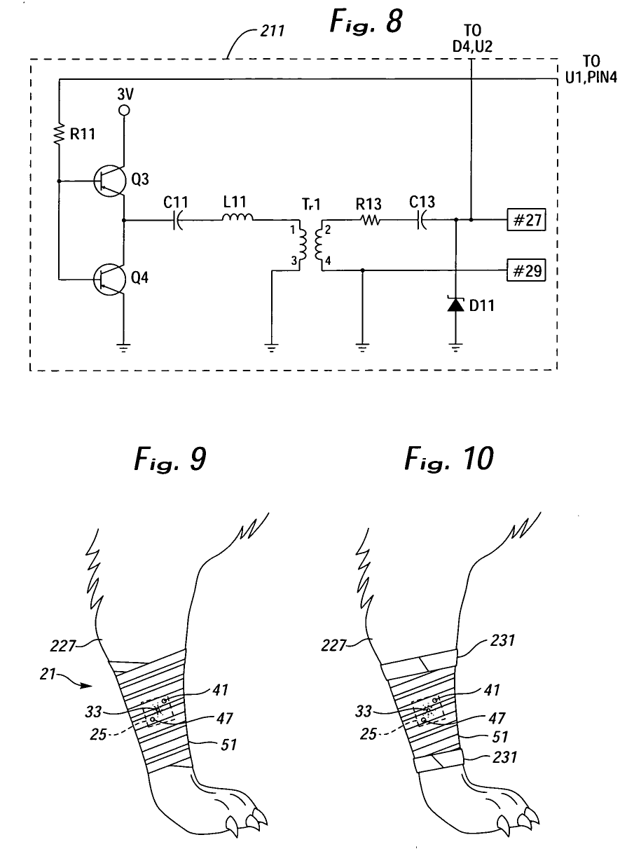

Referring to FIG. 10, a view of the animal protector apparatus 21 is seen as in FIG. 10, but with a band of securing adhesive tape 231 overlying the animal protector apparatus 21 at the top and bottom of the spiral. Such securing adhesive tape 231 may or may not cover the extreme ends of the spiral, and provide some additional resistance to molestation and the animal's ability to remove the flexible circuit 51.

While the present invention has been described in terms of a smart animal wound area protector for long lasting and repeated usage which intelligently monitors and limits the amount of dissuasive shock delivered to an animal to modify its behavior, one skilled in the art will realize that the structure and techniques of the present invention can be applied to many clothing appliances and especially appliances which utilize the embodiments of the invention or any process which utilizes the apparatus and steps of the invention.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1. a wound disturbance protection device comprising:
a circuit assembly comprising:
a sensible voltage output circuit having an output;
a micro controller controllably connected to the direct current-direct current circuit for triggering the output of the sensible voltage output circuit;
a potential detection circuit connected to the output of the sensible voltage output circuit and to an input of the micro controller;
a battery connected to power the sensible voltage output circuit, the micro controller and the potential detection circuit; and
a flexible extended circuit connected to the output of the sensible voltage output circuit.

2. The wound disturbance protection device as recited in claim 1 wherein the sensible voltage output circuit outputs a direct current voltage.

3. The wound disturbance protection device as recited in claim 2 wherein the sensible voltage output circuit outputs a voltage of from about nine to ten times the voltage of the battery.

4. The wound disturbance protection device as recited in claim 1 wherein the sensible voltage output circuit outputs an alternating voltage.

5. The wound disturbance protection device as recited in claim 1 wherein the battery has a nominal voltage of about three volts and the sensible voltage output circuit outputs a voltage of at least twenty-five volts.

6. The wound disturbance protection device as recited in claim 1 and wherein the flexible extended circuit further comprises:
an area of non-conductive material having a first side and a second side;
a first conductor attached to the first side of the non-conductive material;
a second conductor attached to the first side of the non-conductive material and spaced apart from the first conductor;
a layer of adhesive attached to the second side of the non-conductive material.

7. The wound disturbance protection device as recited in claim 1 and wherein the micro controller is configured to trigger the output of the direct current-direct current circuit upon detecting the presence of a drop in the potential between the first and second conductors from contact of a third object and the first and second conductors.

8. A wound disturbance protection device comprising:
a flexible extended circuit having an area of non-conductive material having a first side and a second side;
a first conductor attached to the first side of the non-conductive material;
a second conductor attached to the first side of the non-conductive material and spaced apart from the first conductor;
a layer of adhesive attached to the second side of the non-conductive material; and
a controlled sensible voltage output circuit, connected to the first and second conductors for applying a time limited voltage potential between the first and second conductors upon detecting contact between the first and second conductors by a structure.

9. The wound disturbance protection device recited in claim 8 wherein the flexible extended circuit has a first end and a second end and wherein the controlled sensible voltage output circuit is attached to the flexible extended circuit spaced apart from the first and second ends of the flexible extended circuit.
